(19) United States
(12) Patent Application Publication
(10) Pub. No.: US 2015/0058093 A1
(43) Pub. Date: Feb. 26, 2015

(54) REUSABLE USER INTERFACE CONTROL AND RANKING CIRCLE

(71) Applicant: Daniel Jakobs, Ettlingen - Bruchhausen (DE)

(72) Inventor: Daniel Jakobs, Ettlingen - Bruchhausen (DE)

(21) Appl. No.: 13/973,471

(22) Filed: Aug. 22, 2013

(51) Int. Cl. G06Q 10/06

(52) U.S. Cl. CPC G06Q 10/06393
USPC 705/7.39

(57) ABSTRACT

A system and method for using a ranking circle display, including retrieving state information and progress information for one or more key performance indicators, displaying a page with one or more ranking circles on a portable electronic device, each ranking circle including state information and progress information of a key performance indicator, receiving a user input at the portable electronic device indicating that the user is selecting one of the ranking circles displayed on the page, and in response to selecting one of the ranking circles, displaying additional key performance indicator information or controls for the selected ranking circle.

### BACKGROUND

In today's competitive marketplace, managers of organizations need to make quick decisions based on constantly changing market conditions. Although organizations track and store ample amounts of data, managers and other users need quick and simple ways to analyze business environments, share their findings, and make prompt decisions.

Unfortunately, existing services are often complicated and do not always provide real-time analysis of present market conditions. Computer applications, such as customer relationship managers (CRMs) and other business management applications, allow vendors and service providers to track a variety of metrics relating to their customers. For example, in a CRM application, various data, such as sales metrics for each customer, may be analyzed. In addition, a subset of metrics that quantify performance relative to a business objective, also known as key performance indicators (KPI), may be tracked to evaluate the status of a customer relationship. In CRM systems, data is typically compiled into a series of spreadsheets, charts, and graphs that must then be analyzed and interpreted by a sophisticated user. Thus, managers are limited in how fast they can make decisions and on what data they make such decisions.

Accordingly, the inventor has identified a need to display KPIs and other information in a more efficient manner.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 illustrates a representative view of an example ranking circle according to an example embodiment.

FIG. 2 illustrates a representative view of an electronic device having a customer relationship application and ranking circle display according to an example embodiment.

FIG. 3 illustrates a system level architecture that depicts the interaction between a remote electronic device and a backend system according to an example embodiment.

FIG. 4 illustrates a method for displaying a ranking circle according to an example embodiment.

FIG. 5 illustrates a representative architecture of a portable electronic device according to an example embodiment.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, which may include one or more other physical user-interface devices, such as a keyboard and or mouse.

The portable communication device may support a variety of applications, such as telephone, text messenger, and customer management applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a customer relationship application is used as an example embodiment, but it should be understood that the user interfaces and associated methods may be applied to other applications.

By applying a customer relationship application and ranking circle display according to the present disclosure, users will be better equipped to analyze vast amounts of data, and make more informed decision in real-time. Embodiments of the present disclosure address the above discussed disadvantages of existing CRMs by providing a customer relationship application having one or more ranking circle displays to depict KPIs. The systems and methods may include one or more ranking circle displays. In response to a user input selecting one of the KPIs, additional details or controls for the selected KPI may be displayed. Including multiple KPIs in a single cockpit allows users to make more informed business decisions at a quicker pace. In addition, the customer relationship application allows managers to configure and access their KPIs in a personalized cockpit.

The described systems and methods utilize several types of information (i.e., KPIs) that include, but are not limited to, length of relationship (e.g., less than a year, one to three years, three to five years, more than five years), time since last engagement (e.g., more than two years, one to two years, less than a year, ongoing), cost of average engagement (e.g., less than $1000, $1001-$3000, $3001-$5000, more than $5000), duration of average engagement (e.g., less than a week, one week to four weeks, one month to three months, more than three months). The customer relationship application may access local and/or remotely stored information. A calculation engine analyzes these data to provide a variety of ranking circles and KPIs in real-time.

A customer relationship application that allows the user to customize one or more KPIs and ranking circles is provided. For example, each customer may be configured with a different set of KPIs. Alternatively, KPIs may be selected based on the type of relationship. For example, one set of KPIs may be used to evaluate client or customer relationships, and another set of KPIs may be used to evaluate vender performance.

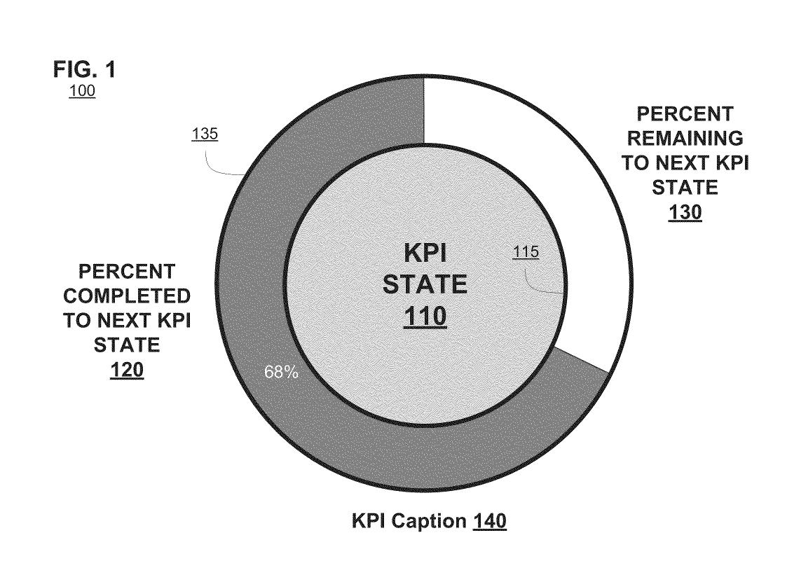

FIG. 1 illustrates an example ranking circle according to an example embodiment. As shown in FIG. 1, the ranking circle 100 may include KPI state information 110, arc 120 depicting progress towards the next KPI state, and caption 140. In addition, optional borders 115 may be displayed between KPI state information 110 and arc 120. Similarly, optional border 135 may be displayed on the outside perimeter of ranking circle 100, i.e. outside arc 120.

Here, KPI state information 110 may be represented using any alphanumeric combination. For example, KPI state information 110 may be represented by a single letter (e.g., state “A”) or by a symbol (e.g., “!” to represent an important or emergency state). Alternatively, a phrase describing the KPI and state may be used (e.g., “length of relationship: 5+”). In yet another alternative, the inner circle depicting KPI state information 110 may also identify KPI states using color. For example, the “!” symbol may be accompanied by a red background to visually depict importance of a current KPI state. In this manner, coloring may be rank dependent. Visualizations of KPI state information 110 may be generated by a remote electronic device based on information supplied by a backend system.

Alternatively, or in addition, a title or caption 140 may be provided adjacent (e.g., above, beneath, when highlighted or selected) to the ranking circle 100. For example, the caption 140 of a ranking circle 10 may read “length of relationship”, and the KPI state information 110 may read “5+” to indicate a relationship lasting longer than five years.

In addition, arc 120 depicts progress towards the next KPI state 120. As a result, arc 130 is also generated to depict the progress remaining to reach the next KPI state. In other words, the arc 120, which is disposed around the inner circle dedicated to KPI state information 110, describes an already achieved progress amount until the next KPI “rank” is reached. Here, either arc 120 or 130 may be depicted with a numerical value (e.g., 68%) indicating the progress completed and/or remaining. In some instances, the inner portion of arc 120 may partially overlap the inner circle dedicated to KPI state information 110. Although KPI state information 110, arc 120, and arc 130 are depicted in gray, black, and white respectively, numerous color combinations are possible.

The ranking circle 100 may be defined by one or more properties described in the table below.

TABLE 1

| Property | Value Type | Description |
|---|---|---|
| RankingCircleWidth | Integer | Overall Width |
| RankingCircleHeight | Integer | Overall Height |
| InnerRingRadius | Integer | In combination, the |
| | | InnerRingRadius and |
| OuterRingRadius | Integer | OuterRingRadius define the |
| | | thickness of the arc 120. |
| MaximumRingUnits | Integer | Represents a full arc (i.e., |
| | | a ring) indicating that the |
| | | next KPI state has been |
| | | reached. |
| | | MaximumRingUnits = 100% |
| RingValue | Integer | Length of arc 120 is |
| | | calculated using RingValue, |
| | | whereas MaximumRingUnits |
| | | represent a maximum length. |
| RankingText | String | Text of caption 140. |
| RankingTextForRanking | String | Text displayed as KPI state |
| Value | | information 110, inside |
| | | inner circle. |
| Tweenduration | Integer | Animation time in |
| | | milliseconds. From arc |
| | | length = 0 to arc length = |
| | | RingValue. |

In addition, example source code implementing the ranking circle is provided. The example source code is operational in the SAP® UI5 environment, but the ranking circle is not limited thereto. Although the example software code is primarily intended to support enablement and written description requirements, SAP® also reserves all rights, including copyrights © 2013.

```
jQuery.sap.require(“sap.ui.core.Control”);
jQuery.sap.require(“CUAN_CA_LIB._libraryCommons”);
sap.ui.core.Control
extend(
    “sap.hpa.cuan.calib.RankingCircle”,
    {
      metadata : { // the Control API
        properties : {
          rankingCircleWidth : {
            type : “int”,
            group : “Misc”,
            defaultValue : “100”
          },
          rankingCircleHeight : {
            type : “int”,
            group : “Misc”,
            defaultValue : “100”
          },
          outerRingRadius : {
            type : “int”,
            group : “Misc”,
            defaultValue : “50”
          },
          innerRingRadius : {
            type : “int”,
            group : “Misc”,
            defaultValue : “35”
          },
          maximumRingUnits : {
            type : “int”,
            group : “Misc”,
            defaultValue : “100”
          },
          ringValue : {
            type : “int”,
            group : “Misc”,
            defaultValue : “35”
          },
          rankingTextForRankingValue : {
            type : “string”,
            group : “Misc”,
            defaultValue : “”
          },
          tweenduration : {
            type : “int”,
            group : “Misc”,
            defaultValue : “750”
          },
          mouseOverEnabled: {
            type: “boolean”,
            group: “Misc”,
            defaultValue: true
          }
        },
      },
      renderer : function(oRm, oControl) {
        oRm.write(“<div”);
        oRm.writeControlData(oControl);
        oRm.addClass(“calib-rankingCircle”);
        oRm.writeClasses( );
        oRm.write(“ style=‘width:”+
oControl.getRankingCircleWidth( ) +“px’>”);
        oRm.renderControl(oControl.oD3HTMLContainer);
        oRm.write(“</div>”);
      },
        _getCombinedId : function(subId){
        return this.getId( ) + “-” + subId;
      },
      init : function( ) {
        var thiz = this;
        this.oD3HTMLContainer = new sap.ui.core.HTML({
          content : “<div
id=“‘+this._getCombinedId(“D3RankingCircle”)+’”></div>”,
          afterRendering: function(e)
          {
            thiz.renderD3RankingCirlce.call(thiz,e);
          },
        });
        this.oD3HTMLContainer.setParent(this);
      },
```

| | |
|---|---|
| onDatasetDependentColorCalculationForOuterCircleFill | : |

```
function(dataset){
        return “transparent”;
      },
```

| | |
|---|---|
| onDatasetDependentColorCalculationForInnerCircleFill | : |

function(dataset){

| | |
|---|---|
| var iValueInProzent = dataset.ringValue | / |

```
dataset.maximumRingUnits * 100;
        if (iValueInProzent < 33)
        {
          return “red”;
        }
        else if (iValueInProzent < 66)
        {
          return “yellow”;
        }
        else
        {
          return “green”;
        }
      },
```

| | |
|---|---|
| onDatasetDependentColorCalculationForRingFill | : |

```
function(dataset){
        return “lightgrey”;
      },
      renderD3RankingCirlce : function(e){
        /* D3 content*/
```

| | |
|---|---|
| var bMouseOverEnabled | = |

```
this.getMouseOverEnabled( );
        var iWidth = this.getRankingCircleWidth( );
        var iHeight = this.getRankingCircleHeight( );
        var iOuterRadius = this.getOuterRingRadius( );
        var iInnerRadius = this.getInnerRingRadius( );
        var iMaximumRingUnits = this.getMaximumRingUnits( );
        var iRingValue = this.getRingValue( );
        var
```

| | |
|---|---|
| fnDatasetDependentColorCalculationForOuterCircleFill | = |

this.onDatasetDependentColorCalculationForOuterCircleFill;
var

| | |
|---|---|
| fnDatasetDependentColorCalculationForInnerCircleFill | = |

this.onDatasetDependentColorCalculationForInnerCircleFill;

| | |
|---|---|
| var sRankingTextForRankingValue | = |

this.getRankingTextForRankingValue( );

| | |
|---|---|
| var fnDatasetDependentColorCalculationForRingFill | = |

```
this.onDatasetDependentColorCalculationForRingFill;
        var iTweenduration = this.getTweenduration( );
        var aData  =  [{  ringValue  :  iRingValue,
maximumRingUnits : iMaximumRingUnits, previousRingValue : 0}];
        var fnArcScale =
  d3.scale.linear( ).domain([0,iOuterRadius*2]).range([0,iWidth]);
        jQuery(“#” + this._getCombinedId(“D3RankingCircle”)
+ “ svg”).remove( );
```

| | |
|---|---|
| var svg = d3.select(“#” | + |

```
this._getCombinedId(“D3RankingCircle”)).append(“svg:svg”)
        .attr(“width”, iWidth)
        .attr(“height”, iHeight)
        .append(“svg:g”)
        .attr(“transform”, “translate(0,“ + (iHeight / 2) + ”)”)
        .on(“mouseover”, mouseOver)
        .on(“mouseout”, mouseOut);
        var OuterCircle = svg
        .data(aData)
        .append(“circle”)
        .attr(“class”, “outerCircle”)
        .attr(“cx”, iWidth/2)
        .attr(“r”, fnArcScale(iOuterRadius)-1)
        .attr(“fill”,function(d){return
fnDatasetDependentColorCalculationForOuterCircleFill(d);});
        var InnerCircle = svg
        .data(aData)
        .append(“circle”)
        .attr(“class”, “innerCircle”)
        .attr(“cx”, iWidth/2)
        .attr(“r”, fnArcScale(iInnerRadius)+2)
        .attr(“fill”,function(d){return
fnDatasetDependentColorCalculationForInnerCircleFill(d);});
        var RatingText = svg.append(“svg:text”)
        .attr(“class”, “rankingText”)
        .attr(“x”,iWidth/2) // y already set in translate above
        .attr(“y”,(iHeight/2)  -  (fnArcScale(iInnerRadius  *
1.8)/2))
        .attr(“font-size”,fnArcScale(iInnerRadius * 1.6))
        .text(sRankingTextForRankingValue);
        var arc = d3.svg.arc( )
        .innerRadius(fnArcScale(iInnerRadius))
        .outerRadius(fnArcScale(iOuterRadius)-2)
        .startAngle(0)
        .endAngle(function(d) {
          return (d.ringValue / d.maximumRingUnits) * 2
* Math.PI;
        });
        var path = svg.selectAll(“path”)
        .data(aData);
        path.enter( ).append(“svg:path”)
        .attr(“class”, “rankingPath”)
        .attr(“fill”,function(d){return
fnDatasetDependentColorCalculationForRingFill(d);})
        .attr(“transform”, “translate(” + (iWidth / 2) + “,0)”)
        .transition( )
        .ease(“elastic”)
        .duration(iTweenduration)
        .attrTween(“d”, arcTween);
        path.transition( )
        .ease(“elastic”)
        .duration(iTweenduration)
        .attrTween(“d”, arcTween)
        .attr(“fill”,function(d){return
fnDatasetDependentColorCalculationForRingFill(d);});
        path.exit( ).transition( )
        .ease(“bounce”)
        .duration(iTweenduration)
        .attrTween(“d”, arcTween)
        .remove( );
        function ColorLuminance(hex, lum) {
          // validate hex string
          hex = String(hex).replace(/[\hat{ }0-9a-f]/gi, ”);
          if (hex.length < 6) {
```

| | |
|---|---|
| hex | = |

```
hex[0]+hex[0]+hex[1]+hex[1]+hex[2]+hex[2];
          }
          lum =lum ∥ 0;
          // convert to decimal and change luminosity
          var rgb =“#”, c, i;
          for (i = 0; i < 3; i+=1) {
            c = parseInt(hex.substr(i*2,2), 16);
            c = Math.round(Math.min(Math.max(0, c
+ (c * lum)), 255)).toString(16);
            rgb += (“00”+c).substr(c.length);
          }
          return rgb;
        }
        function mouseOver( ){
          if (!bMouseOverEnabled) return;
          OuterCircle.transition( ).duration(250)
          .style(“opacity”,0);
          InnerCircle.transition( ).duration(250)
          .style(“opacity”,0.9)
          .attr(“fill”,function(d){return
ColorLuminance(fnDatasetDependentColorCalculationForInnerCircleFill(d),
0.15);});
          path.transition( ).duration(250)
          .attr(“fill”,function(d){return
ColorLuminance(fnDatasetDependentColorCalculationForRingFill(d),
-0.3);});
        function mouseOut( ){
          if (!bMouseOverEnabled) return;
          OuterCircle.transition( ).duration(250)
          .style(“opacity”,1);
          InnerCircle.transition( ).duration(250)
          .style(“opacity”,1)
          .attr(“fill”,function(d){return
fnDatasetDependentColorCalculationForInnerCircleFill(d);});
          path.transition( ).duration(250)
          .attr(“fill”,function(d){return
fnDatasetDependentColorCalculationForRingFill(d);});
        };
        function arcTween(b) {
          var  i  = d3.interpolate({ringValue:
b.previousRingValue}, b);
          return function(t) {
            return arc(i(t));
          };
        };
      },
      exit : function( ) {
        this.oD3HTMLContainer.destroy( );
      },
    });
```

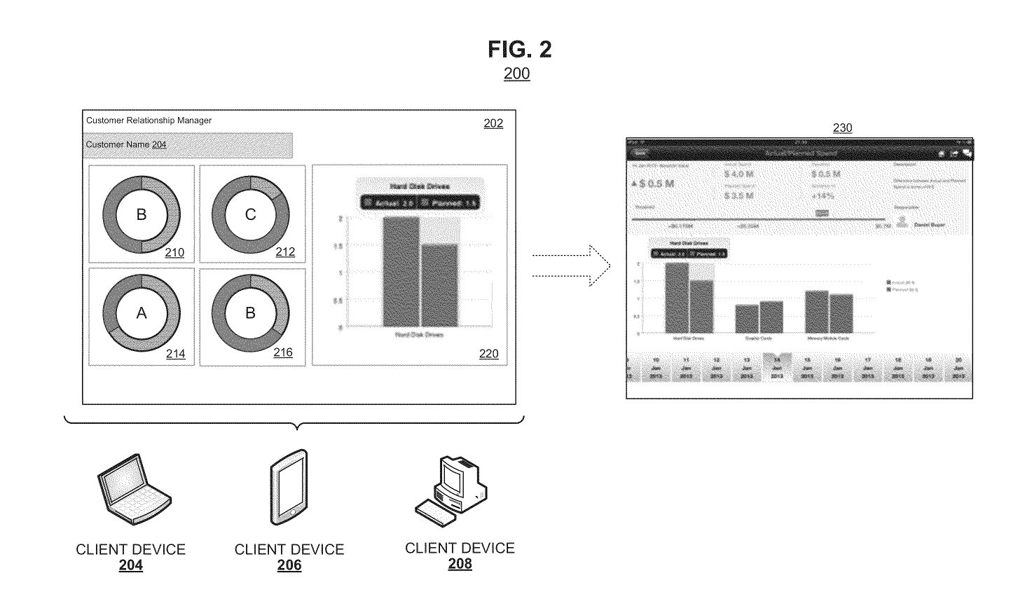

FIG. 2 illustrates a representative view of an electronic device having a customer relationship application and ranking circle display according to an example embodiment. Although the ranking circle may be applied in numerous manners and applications, a customer relationship application is just one example that will be used to illustrate the features of the ranking circle.

As shown in FIG. 2, the customer relationship application 200 may include a main display 202 for each customer 204. The example main display 202 may illustrate a plurality of KPIs using a plurality of ranking circles 210-216. More detailed information for a particular KPI may be illustrated in either of expanded view 220 or expanded screen 230. The customer relationship application 200 may be displayed on a variety of client devices 204, 206, or 208 which may include, for example, a mobile device (e.g., mobile phone or a smartphone), a personal computer, a laptop, a tablet, or the like.

Each of the plurality of ranking circles 210-216 may display the current state of a KPI as well as the progress towards the next higher KPI state. In addition, more detailed information may be displayed in expanded view 220 for a selected ranking circle. Alternatively, additional detailed information may be displayed in an expanded screen 230. Here, expanded view 220 may be invoked by a single click or touch of a selected ranking circle. Similarly, a user may navigate to an expanded screen 230 by double clicking or double tapping a selected ranking circle. A ranking circle 210-216 may be selected or hovered over by a finger or mouse. Here, the customer relationship application may increase the luminosity or the selected ranking circle by a predetermined amount (e.g., 20%).

In some instances, users may navigate the customer relationship application to display additional details corresponding to the information of the respective ranking circle. For example, as shown in FIG. 2, expanded view 220 or expanded screen 230 may include charts and/or graphs to visually depict the performance of the organization. The charts and/or graphs may include predicted performance of the organization. The expanded view 220 or expanded screen 230 may display information related to the one or more of KPIs and corresponding ranking circles 210-216.

Each customer 204 may include a predetermined or user-defined set of KPIs and corresponding ranking circles 210-216 that are selected and/or arranged based on user preferences. For example, each customer may be configured with a different set of KPIs. Alternatively, KPIs may be selected based on the type of relationship. For example, one set of KPIs may be used to track and analyze client relationships, and another set of KPIs may be used to track and analyze vender performance. In either case, the plurality of KPIs and corresponding plurality of ranking circles 210-216 may be customized by the user.

The customer relationship application 200 may provide users with a clearly structured visualization of the information using a plurality of ranking circles 210-216. In addition, the user may navigate the customer relationship application using a variety of input devices. The client device 204, 206, or 208 may include one or more input devices, such as a touch screen, a touch pad, a mouse, or a keyboard, that allow a user to navigate the customer application.

Each of the ranking circles 210-216 may provide real-time information (e.g., length of relationship, time since last engagement, cost of average engagement, duration of average engagement) to the user of main display 202. Based on the information provided in the ranking circles 210-216, the user may perform transactional processes (e.g., decide to accept additional engagements) or management processes (e.g., decide to hire additional staff based on growing customer demand). Automated tasks (e.g., purchasing, transfer of funds, manufacturing adjustments, etc.) may be set by the user based on the information provided in the ranking circles 210-216.

If desired, the user may set one or more thresholds for each KPI, such that notifications are sent to the user when the threshold is met. For example, a user may desire to be notified when KPI data indicates that a KPI state is halfway to the next KPI state. The notification may be sent by numerous electronic means, such as e-mail, text message, or notification within the customer relationship application.

In some instances, customer relationship application may also include a collaboration portal (not shown) that allows a user to share information with others. For example, the collaboration portal may connect customers, partners, vendors, and/or employees so that one or more KPIs may be shared and collaboration achieved on a business task. The ranking circles 210-216 depicted in the main display 202 and/or information underlying or associated with with the ranking circles 210-216 may be provided to other users through the collaboration portal.

The ranking circles 210-216 may be rearranged, resized, added and/or removed by a user to customize the display of the ranking circles on the main display 202. For example, a user may tap and hold on a desired ranking circle and then drag the ranking circle to move the selected ranking circle to a new location on the display page. In another example, each ranking circles 210-216 may include a context menu. The context menu may be invoked by selecting a ranking circle 210-216 (e.g., right click or a double tap). The example context menu may include ranking circle configuration and format settings, additional information, options to delete the ranking circle, and other options to modify or control the ranking circle.

The types of changes that a user is authorized to make to the main display 202 may depend on the role of the user. In other words, the customization of the page 202 and/or one or more ranking circles 210-216 may be based on the role of the user. For example, customer users may only be allowed to view ranking circles 210-216 in the main display 202 and may not be provided with options to change the settings or arrangement of the ranking circles 210-216. By contrast, the service provider users may be allowed to make any type of changes to the ranking circles 210-216 on the main display 202. In another example, the role of the user may be used as the basis to determine which ranking circles 210-216 are displayed or modifiable.

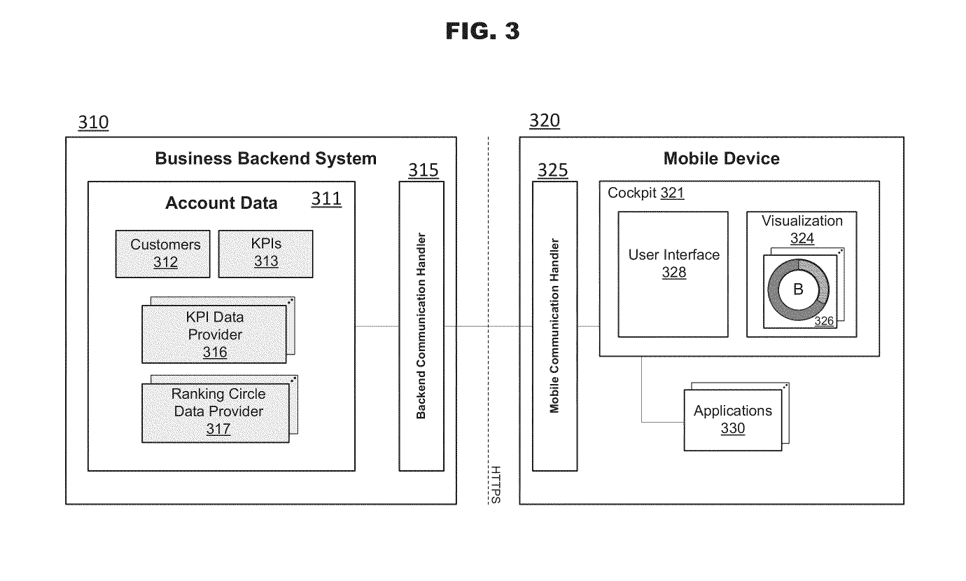

FIG. 3 illustrates a system level architecture 300 that depicts the interaction between a remote electronic device and a backend system according to an example embodiment.

As shown in FIG. 3, the system level architecture includes a business backend system 310 (e.g., SAP® HANA database) that is connected to a portable electronic device 320. The business backend system 310 can be connected to portable electronic device 320 using known or expected network technologies, such as wireless local area networks (WLAN) or wireless wide area networks (WWAN), some examples of which include WiFi, long term evolution (LTE), and the like. Backend communication handler 315 and mobile communication handler 325 manage communications functions for the business backend system 310 and mobile device 320, respectively.

Business backend system 310 includes one or more account database 311 that store several types of information that can be queried by the mobile device 320. For example, account database 311 stores a variety of customer and KPI data, such as length of relationship, time since last engagement, cost of average engagement, duration of average engagement, etc. Account database 311 may include customer identification data 312 as well as associated KPI data 313. For example, the KPI data 313 may centrally maintain KPIs for each customer. Here, both pre-defined as well as user-defined KPIs may be centrally stored within KPI data 313.

Backend system 310 may receive and/or reply to data requests from a remote mobile device 320 through KPI provider 316 and/or ranking circle information provider 317. Here, expanded KPI data may be transmitted through KPI provider 316 whereas KPI data necessary to generate the desired ranking circles may be transmitted through ranking circle information provider 317.

Within the mobile device 320, customer management cockpit 321 may include a visualization module 324 for generating and displaying one or more ranking circles 326. Each ranking circle 326 in the cockpit 321 may be generated based on data retrieved from the backend system 310. In other words, software code may be adapted to produce the visualization of the KPI data as a ranking circle 326.

The KPI cockpit 321 may include a user interface 328 to render the pages or displays of the customer relationship application. User interface 324 may generate one or more pages of the customer relationship application to be provided on a display of a mobile device 320 via an Internet browser or a standalone application. The user interface 328 may employ SAP® UI5 (i.e., a user interface for HTML5) and other display techniques. More generally, the user interface 328 may be based on any document language (e.g., markup language) or other-type language for structuring and presenting content to the user. The document language may include HyperText Markup Language (HTML) (e.g., HTML5), but is not so limited.

The KPI cockpit 321 may provide the user with customizable features (e.g., adding or removing one or more ranking circles 326 from the display). The customizable features may affect which ranking circles 326 are displayed, how they are displayed on a display page, etc. In addition, the configuration of each ranking circle 326 may be defined via a user preferences menu.

The applications 330 may include applications that are associated with one or more ranking circles 326. For example, applications 330 may include charting, spreadsheet, presentation, or other applications that may be invoked to display expanded KPI information. In another example, applications 330 may include HTML (e.g., HTML5 applications). The applications 330 may include applications that are running outside of the KPI cockpit 321. The user may navigate to the applications 330 by making corresponding selections on the ranking circles 326. Parameters describing the context of the navigation from the ranking circle 326 within the KPI cockpit 321 to the application 330 may be passed from the ranking circle 326 to the called application 330.

As discussed above, the KPI cockpit 321 may render displays and ranking circles 326 of the customer relationship application. The information (e.g., ranking circles and other KPI information) may be retrieved from the backend system 310. The information may be retrieved via a data access request using a known protocol (e.g., HTTP or Open Data Protocol (OData)). In one embodiment, the request may be made with OData via HTTP. One or more requests may be used to provide of the needed KPI information.

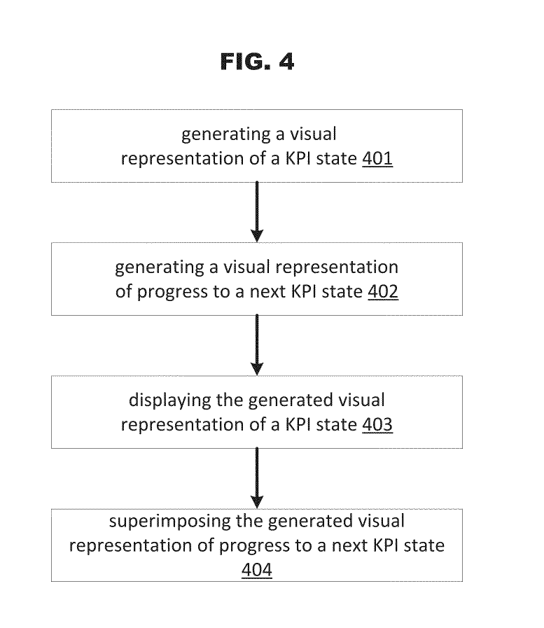

FIG. 4 illustrates a method for displaying a ranking circle according to an example embodiment.

At step 401, one or more visualization modules of the portable electronic device generate a visual representation of a KPI state. The customer relationship application can display KPI state information using any alphanumeric combination. The KPI state information may be displayed within an inner circle of the ranking circle. For example, KPI state information may be represented by a single letter (e.g., “A”) or by a symbol (e.g., “!”). Alternatively, a phrase describing the KPI may be used (e.g., “length of relationship”). Visualizations of KPI state information may be generated by a remote electronic device based on information supplied by a backend system.

Next, at step 402, one or more visualization modules of the portable electronic device generate a visual representation of progress achieved toward a next KPI state. Here, an arc representing the amount achieved between KPI states is generated. Similar to visualizations of KPI state information, visualizations of progress to a next KPI state may be generated by a remote electronic device based on information supplied by a backend system.

At step 403, the portable electronic device displays the visual representation of KPI state information in an inner circle of a ranking circle display. Soon thereafter, at step 404, the arc representation of progress to a next KPI state is superimposed on the inner circle of the ranking circle display, as illustrated in FIG. 1. Once the arc is superimposed on the ranking circle, the ranking circle may be moved to various locations within the display of the customer relationship application. In the case of a touch screen interface, a user may simply drag the ranking circle to its desired location.

As discussed above, the ranking circle may be displayed alone or with other ranking circles and/or other expanded KPI information. In addition, the ranking display attributes may be customized in response to user preferences.

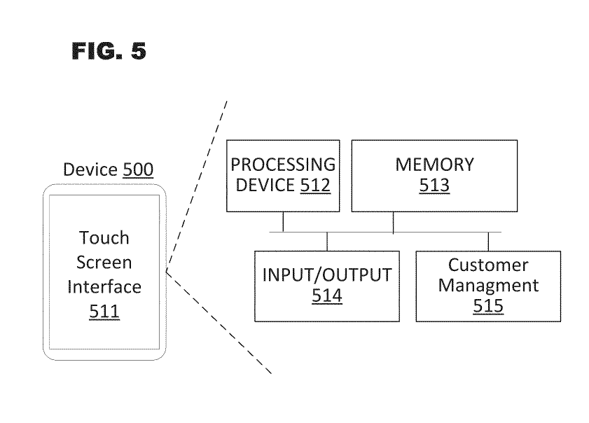

FIG. 5 illustrates a representative architecture of a portable electronic device according to an example embodiment.

A portable electronic device 500 may include a touch screen interface 511, processing device 512, memory 513, and input/output module 514. The touch screen interface 511 may include a display, which may be a touch screen, capable of displaying data to a user of the portable electronic device 500. Portable electronic device 500 may also include a customer management module 515 that generally implements the functionality of the customer relationship application. The components and functions of the customer management module 515 are explained in detail with reference to FIGS. 2 and 3.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor. The input/output module 514 manages the functionality of touch screen interfaced 511. For example, input/output module 514 may include functionality for identifying a touched first ranking circle within the customer relationship application. An alternate ranking circle may be selected by touching the alternate ranking circle.

Memory 513 may include a computer readable medium storing application modules, which may include instructions associated with applications and modules of the portable electronic device 500.

The portable electronic device may contain a processing device 512, memory 513, and a communications device 325 (as shown in FIG. 2), all of which may be interconnected via a system bus. In various embodiments, the device 500 may have an architecture with modular hardware and/or software systems that include additional and/or different systems communicating through one or more networks via communications device 325.

Communications device 325 may enable connectivity between the processing devices 512 in the device 500 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates. In some instances, a cache in memory 513 may store calculated changes to the profit per square foot based on modifications to product displays.

Processing device 512 may perform computation and control functions of a system and comprises a suitable central processing unit (CPU). Processing device 512 may include a single integrated circuit, such as a microprocessing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touch screen interface 511, in some instances the processing device 512 and the touch screen interface 511 and/or one or more of the modules 514 and 515 may be functionally integrated to perform their respective functions.

It will be apparent to those skilled in the art that various modifications and variations can be made in the reusable interface control and ranking circle of the present disclosure without departing from the spirit or scope of the disclosure. Thus, it is intended that the present disclosure cover the modifications and variations of this disclosure provided they come within the scope of the appended claims and their equivalents.

We claim:

1. A method, the method comprising:
retrieving state information and progress information for one or more key performance indicators;
displaying a page with one or more ranking circles on a display, each ranking circle including state information and progress information of a key performance indicator;
receiving a user input at the portable electronic device indicating that the user is selecting one of the ranking circles displayed on the page; and
in response to selecting one of the ranking circles, displaying additional key performance indicator information or controls for the selected ranking circle.

2. The method according to claim 1, wherein state information of a key performance indicator is displayed within an inner circle of a ranking circle.

3. The method according to claim 1, wherein progress information of a key performance indicator is superimposed as an arc along a perimeter of an inner circle of a ranking circle.

4. The method according to claim 1, wherein configuration information of at least one of the ranking circles is modified.

5. The method according to claim 2, wherein at least one updated ranking circle is displayed based on the modified configuration information.

6. The method of claim 1, wherein the color of an inner circle of a ranking circle is dependent upon state information.

7. The method of claim 1, wherein the page is modified to display ranking circles for different key performance indicators.

8. A non-transitory computer readable storage medium storing one or more programs configured to be executed by a processor, the one or more programs comprising instructions for:
retrieving state information and progress information for one or more key performance indicators;
displaying a page with one or more ranking circles on a display, each ranking circle including state information and progress information of a key performance indicator;
receiving a user input at the portable electronic device indicating that the user is selecting one of the ranking circles displayed on the page; and
in response to selecting one of the ranking circles, displaying additional key performance indicator information or controls for the selected ranking circle.

9. The computer readable storage medium of claim 8, wherein state information of a key performance indicator is displayed within an inner circle of a ranking circle.

10. The computer readable storage medium of claim 8, wherein progress information of a key performance indicator is superimposed as an arc along a perimeter of an inner circle of a ranking circle.

11. The computer readable storage medium of claim 8, wherein configuration information of at least one of the ranking circles is modified.

12. The computer readable storage medium of claim 11, wherein at least one updated ranking circle is displayed based on the modified configuration information.

13. The computer readable storage medium of claim 8, wherein the color of an inner circle of a ranking circle is dependent upon state information.

14. The computer readable storage medium of claim 8, wherein the page is modified to display ranking circles for different key performance indicators.

15. A portable electronic device comprising:
one or more process; and
memory storing one or more programs for execution by the one or more process, the one or more programs including instructions for:
retrieving state information and progress information for one or more key performance indicators;
displaying a page with one or more ranking circles on a display, each ranking circle including state information and progress information of a key performance indicator;
receiving a user input at the portable electronic device indicating that the user is selecting one of the ranking circles displayed on the page; and
in response to selecting one of the ranking circles, displaying additional key performance indicator information or controls for the selected ranking circle.

16. The portable electronic device according to claim 15, wherein state information of a key performance indicator is displayed within an inner circle of a ranking circle.

17. The portable electronic device according to claim 15, wherein progress information of a key performance indicator is superimposed as an arc along a perimeter of an inner circle of a ranking circle.

18. The portable electronic device according to claim 15, wherein configuration information of at least one of the ranking circles is modified.

19. The portable electronic device according to claim 18, wherein at least one updated ranking circle is displayed based on the modified configuration information.

20. The portable electronic device according to claim 15, wherein the color of an inner circle of a ranking circle is dependent upon state information.

21. The portable electronic device according to claim 15, wherein the page is modified to display ranking circles for different key performance indicators.

22. A portable electronic device comprising:
a mobile communication handler adapted to retrieve state information and progress information for one or more key performance indicators;
a visualization module adapted to generate one or more ranking circles on a display, each ranking circle including state information and progress information of a key performance indicator; and
a user interface adapted to receive a user input at a touchscreen of the portable electronic device, the user input indicating that the user is selecting one of the ranking circles displayed on the page, and
wherein, in response to selecting one of the ranking circles, the additional key performance indicator information or controls for the selected ranking circle is displayed.
